(19) United States
(12) Patent Application Publication
(10) Pub. No.: US 2024/0135467 A1
(43) Pub. Date: Apr. 25, 2024

(54) METHODS AND SYSTEMS FOR DYNAMIC TAGGING BY CONTENT ASSOCIATION

(71) Applicant: Mark Herschberg, New York, NY (US)

(72) Inventor: Mark Herschberg, New York, NY (US)

(21) Appl. No.: 18/488,384

(22) Filed: Oct. 16, 2023

Related U.S. Application Data
(60) Provisional application No. 63/417,529, filed on Oct. 19, 2022.

(51) Int. Cl. G06Q 50/00

(52) U.S. Cl. CPC G06Q 50/01

(57) ABSTRACT

The present disclosure relates to systems and methods for tagging digital content. Media content to create a post for a digital platform is received. Association identifiers corresponding to the media content are dynamically determined based on correlation parameters. The media content is tagged with the association identifiers to create a modified post for the digital platform. The user is enabled to publish the modified post on the digital platform via a user device.

### FIELD OF THE INVENTION

The present disclosure relates generally to systems and methods for data and content management, and more particularly, to systems and methods for enhancing the process of content identification and automatic and intelligent tagging of media content.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

The use of social media enables individuals to distribute their content to a wider audience, leading to an increase in followers and potential monetization opportunities. Social media algorithms prioritize content that garners greater engagement.

One effective strategy to achieve this is by tagging individuals in posts or comments, as it not only alerts them but also boosts the likelihood of their engagement. Some social media platforms, such as LinkedIn, even actively encourage and suggest tagging others.

An effective tagging strategy requires careful consideration. It may be essential to recognize that indiscriminately tagging numerous individuals can backfire, as certain algorithms may penalize such posts. One particularly logical choice for tagging may be the content creator or owner.

Users can search for the social media handle or a similar form of identification, such as an account username, when quoting or referencing a person. However, there are associated costs and limitations to this process. To begin with, when incorporating third-party content into a conversation on a platform, whether it is on social media, a forum, or any other multi-party platform, there is a notable cost involved in tagging the content source. The individual making the post must navigate the platform's search feature to locate the person being quoted or referenced. For example, if the quote originates from an author (although it could come from various sources), the poster may mention the author's name, but the author may not use the same name on the platform. Additionally, there may be multiple individuals with identical names on the platform, or even fraudulent accounts attempting to impersonate the author. This process of searching and sifting through various options to locate the correct individual may take anywhere from 5 to 30 seconds, roughly equivalent to the time it takes to compose and submit the post. Consequently, this additional time investment effectively doubles the cost associated with posting.

Another significant factor to consider is the potential social awkwardness. The person making the post may be uncertain whether the author or the individual being referenced actually wishes to be tagged. This uncertainty may create a sense of discomfort for the poster, even if they believe that the individual would appreciate the mention in the post.

Furthermore, there are scenarios where the poster may not even be aware that there is someone who wishes to be tagged in the post. In some instances, the poster may assume that the quote or content source is anonymous or unidentifiable and therefore may not realize the need to tag the original source. Alternatively, there may be individuals unknown to the poster who may have an interest in being tagged. For example, when quoting an author, the publisher may want to be tagged, allowing them to offer additional content, information, or even a discount code in the thread. This approach not only enriches the discussion but also provides an opportunity for the publisher to gain insights into audience engagement with the book.

While hashtags do enable people to conduct searches, they may not always be as convenient, and individuals do not typically create hashtags using content.

Therefore, there is a well-established need for an efficient system and method for incorporating a tagging system that can automatically identify and notify relevant entities, even when the poster is unaware of their presence, can enhance engagement, or facilitate valuable connections within the platform.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE INVENTION

This section is provided to introduce certain objects and aspects of the present disclosure in a simplified form that are further described below in the detailed description. This summary is not intended to identify the key features or the scope of the claimed subject matter.

In an aspect, the present disclosure relates to a system including a processor, and a memory operatively connected to the processor, wherein the memory includes processor-executable instructions which, when executed by the processor, cause the processor to receive, from a user device associated with a user, media content to create a post for a digital platform associated with the system, dynamically determine one or more association identifiers corresponding to the media content based on one or more correlation parameters, tag the media content with the one or more association identifiers to create a modified post for the digital platform, and enable the user to publish the modified post on the digital platform via the user device.

In an embodiment, the media content may include at least one of: a text, an image, an audio clip, a video clip, a virtual reality content, meta data, or any combination thereof.

In an embodiment, the one or more association identifiers may correspond to at least one of: direct associations, and indirect associations, wherein the direct associations may correspond to a direct correlation between the media content and the one or more association identifiers, and wherein the indirect associations may correspond to an indirect correlation having one or more intermediary references between the media content and the one or more association identifiers.

In an embodiment, the one or more association identifiers may include at least one of: an identifier of a content creator or other users corresponding to the media content on the digital platform, an identifier of the content creator or other users on another digital platform, a source of the media content, inter-related content corresponding to the media content, or any combination thereof.

In an embodiment, to dynamically determine the one or more association identifiers, the processor may retrieve the one or more association identifiers from a digital database associated with the system, and/or dynamically determine the one or more association identifiers while the media content is received from the user device based on the one or more correlation parameters.

In an embodiment, the one or more correlation parameters may include at least one of: an authorship of the media content, an ownership of the media content, inter-related content corresponding to the media content, expressed interest in the media content or the inter-related content, explicit linkage of the media content, prior reference of use of the media content, keywords, relationship to the user, or any combination thereof.

In an embodiment, the processor may store the one or more association identifiers corresponding to the media content in a digital database associated with the system a priori to the tagging of the media content with the one or more association identifiers.

In an embodiment, to tag the media content with the one or more association identifiers, the processor may tag the media content with the one or more association identifiers and enable the user of the user device to modify the tagged one or more association identifiers, tag the media content with the one or more association identifiers and disable the user of the user device to modify the tagged one or more association identifiers, and/or determine and provide one or more recommendations for the one or more association identifiers to the user to enable the user to select the one or more association identifiers.

In an embodiment, the one or more recommendations may be determined based on at least one of: user activities on the digital platform, user settings, user preferences, and/or machine learning.

In another aspect, the present disclosure relates to a computer-implemented method, including receiving, by a processor associated with a system, from a user device associated with a user, media content to generate a post for a digital platform associated with the system, dynamically determining, by the processor, one or more association identifiers corresponding to the media content based on one or more correlation parameters, tagging, by the processor, the media content with the one or more association identifiers to create a modified post for the digital platform, and enabling, by the processor, the user to publish the modified post on the digital platform via the user device.

In another aspect, the present disclosure relates to a non-transitory computer-readable storage medium comprising instructions executable by a processor, the instructions to cause the processor to carry out the functions performed by the disclosed system.

These and other objects, features, and advantages of the present disclosure will become more readily apparent from the attached drawings and the detailed description of the preferred embodiments, which follow.

### BRIEF DESCRIPTION OF DRAWINGS

The preferred embodiments of the invention will hereinafter be described in conjunction with the appended drawings provided to illustrate and not to limit the invention, where like designations denote like elements, and in which:

FIG. 1 shows an example networked environment in which embodiments of the present disclosure may be implemented;

FIG. 2 shows a block diagram of an example system, in accordance with embodiments of the present disclosure;

FIG. 3 and FIG. 4 show example representations for implementing the example system, in accordance with embodiments of the present disclosure;

FIG. 5 shows a flow chart of an example digital content tagging method, in accordance with embodiments of the present disclosure; and

FIG. 6 shows an example computer system in which or with which embodiments of the present disclosure may be implemented.

Like reference numerals refer to like parts throughout the several views of the drawings.

### DETAILED DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional blocks not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

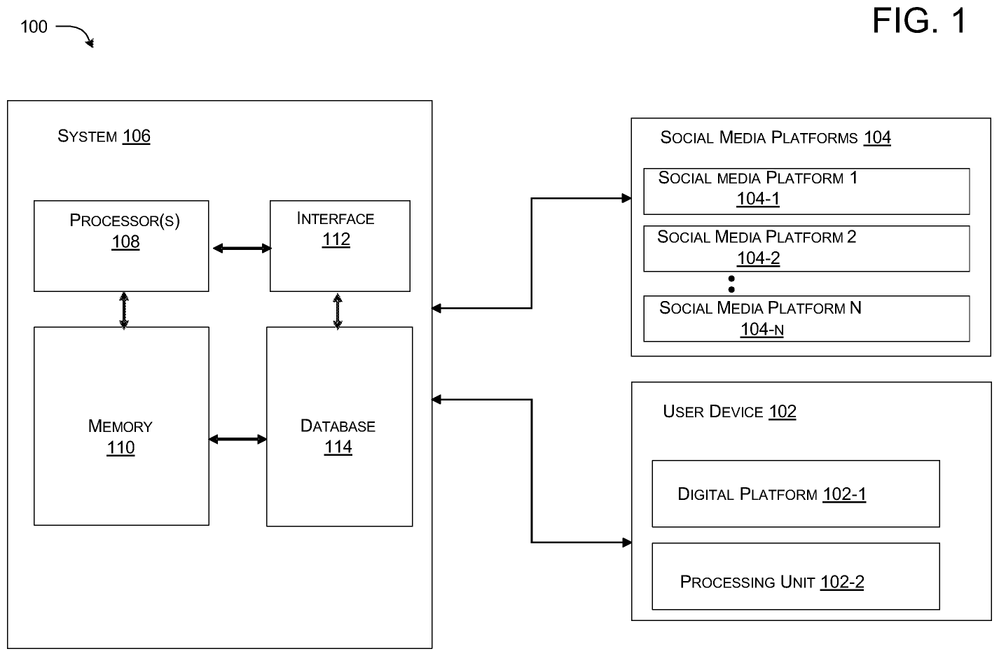

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIGS. 1-6. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its broadest sense that is as meaning “and/or” unless the content clearly dictates otherwise.

The headings and Abstract of the disclosure provided herein are for convenience only and do not interpret the scope or meaning of the implementations.

The various embodiments throughout the disclosure will be explained in more detail with reference to FIGS. 1-6. In particular, shown throughout the figures, the present disclosure is directed towards a digital platform that provides an interface to curate digital content allowing users to easily tag others with the content.

FIG. 1 shows an example networked environment 100 in which embodiments of the present disclosure may be implemented.

Referring to FIG. 1, the networked environment 100 includes a user device 102 operated by a user (not shown), optionally one or more social media platforms (104-1, 104-2 . . . 104-N), and a system 106.

In some embodiments, the user device 102 comprises a digital platform 102-1 communicatively coupled with the system 106. In some embodiments, the digital platform 102-1 may be a mobile application (“app”). The mobile application may be installed on the user device 102. In some embodiments, the digital platform 102-1 may be a web application (e.g., a website or a webpage). In some embodiments, the digital platform 102-1 may be a desktop application. The digital platform 102-1 in conjunction with a processing unit 102-2 may render a graphical user interface on the user device 102 such that a user of the user device 102 may communicate with the system 106 via the graphical user interface rendered on the user device 102. The graphical user interface may be rendered on the user device 102 under control of the system 106. In some embodiments, the digital platform 102-1 may be hosted on the system 106. In some embodiments, the user may use the user device 102 to, but not limited to, send digital or media content, modify the digital content rendered by the system 106, tag the digital content, or the like.

In some embodiments, the user device 102 may include, but is not limited to, a handheld wireless communication device (e.g., a mobile phone, a smart phone, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, and/or any other type of user device 102 with wireless or wired communication capabilities, and the like. In some embodiments, the user device 102 may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user device 102 may include one or more in-built or externally coupled accessories including, but not limited to, a visual aid device such as camera, audio aid, a microphone, a keyboard, and input devices for receiving input from the user such as touch pad, touch enabled screen, electronic pen, and the like. Further, the user device 102 may include, but not be limited by, intelligent, multi-sensing, network-connected devices, that can integrate seamlessly with each other and/or with a central server or a cloud-computing system or any other device that is network-connected.

A person of ordinary skill in the art will appreciate that the user device 102 may not be restricted to the mentioned devices and various other devices may be used.

In accordance with embodiments of the present disclosure, the user may access and interact with a plurality of social media platforms (104-1, 104-2 . . . 104-N). A person of ordinary skill in the art will understand that the one or more social media platforms (104-1, 104-2 . . . 104-N) may be individually referred as the social media platform 104 and collectively referred as the social media platforms 104. In some embodiments, the social media platforms 104 may include social media websites, social media applications, or the like. For example, the social media platforms 104 may include, but not be limited to, Facebook™, Twitter™, Instagram™, Snapchat™, and the like.

In some embodiments, the social media platforms 104 may be accessed by the user via the system 106. In other embodiments, the system 106 may be accessed by the user via the social media platforms 104. In some embodiments, the user may use the digital platform 102-1 and the processing unit 102-2 on the user device 102 that allows the user, for example but not limited to, to send digital or media content, modify the digital content, tag the digital content, and other associated services.

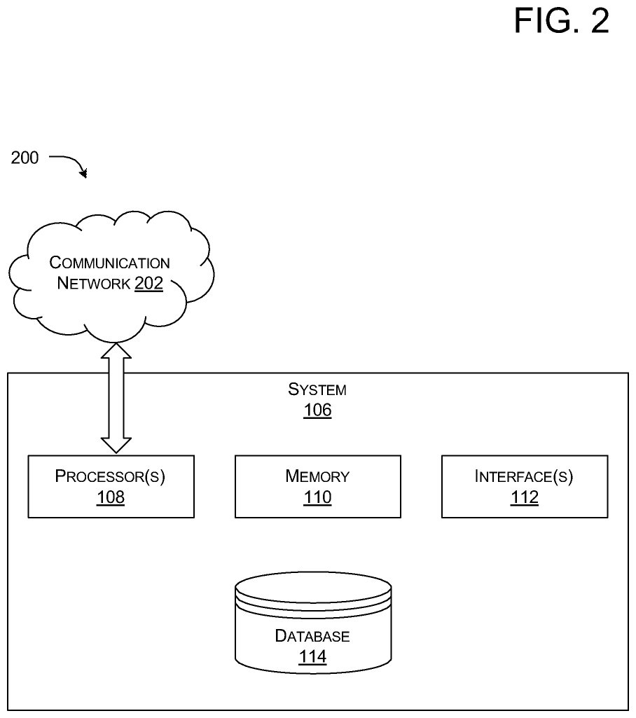

Referring to FIG. 1, the system 106 may include, but is not limited to, one or more processor(s) 108, a memory 110, interface(s) 112, and a database 114. In some embodiments, the processor(s) 108 may communicate with the memory 110. The memory 110 may consist of multiple memory units and store non-transitory instructions that the processor(s) 108 may execute in accordance with embodiments of the present disclosure. In some embodiments, the interface(s) 112 may facilitate communication between the processor(s) 108 and external entities including, but not limited to, the user device 102 and the social media platforms 104. In some embodiments, the interface(s) 112 may employ various communication media, such as radio, optical fiber, telephone, wire, etc. The interface(s) 112 may also include one or more communication networks, including the Internet. Further, the database 114 may be communicatively coupled with the processor(s) 108 and the memory 110. The database 114 may store data in a structured format and provide fast access to the stored data. The processor(s) 108 may access the database 114 to retrieve or store data as required by the present disclosure. In some embodiments, the system 106 may be implemented as a cloud server which may execute operations through web applications, cloud applications, hypertext transfer protocol (HTTP) requests, repository operations, file transfer, and the like. In some embodiments, the system 106 may be implemented as a plurality of distributed cloud-based resources by use of several technologies that are well known to those skilled in the art. This will be explained in detail with reference to FIG. 2.

Referring to FIG. 1, in some embodiments, the system 106 may act as an authentication system that allows cross-network collaboration between multiple digital platforms or web servers as part of a distributed, multi-site user authentication system. For example, the system 106 may allow the user with an ability to access one or more participating digital platforms (e.g., social media platforms 104) with a single sign-in. Although the participating sites still maintain control over permissions, they may use the system 106 rather than hosting and maintaining their own proprietary authentication systems. In alternative embodiments, each of the social media platforms 104 may perform authentication with multiple intermediary nodes or software modules in between. In some embodiments, the database 114 may contain information (e.g., user credentials) necessary to authenticate the user of the user device 102 and also identify which elements of user profile information should be provided to a particular social media platform 104 when the user accesses the system 106 via the digital platform 102-1. A person of ordinary skill in the art will understand that user credentials may include a means for generating an authenticated reference to a single account identifier. For example, the user credentials may include, but not be limited to, a user generated username and password, a mobile phone number, a personal identification number (PIN), and a biometric signature that may be associated with the same profile data of the user for accessing the digital platform 102-1 and the plurality of social media platforms 104 via the system 106.

Although the database 114 is shown as being a part of the system 106, it is to be understood that in other embodiments, the database 114 may be separate from the system 106 and may be hosted on another sever that is communicatively coupled to the system 106. In some embodiments, the database 114 may be cloud-hosted.

In accordance with embodiments of the present disclosure, a user may be enabled to select digital content by accessing the system 106 via the digital platform 102-1. For example, the system 106 may maintain a repository of readily available content that may be selected by the user for creating a post. In some other embodiments, digital content may be sent by the user via the user device 102 to the system 106. Based on the selected and/or received digital content, one or more association identifiers may be dynamically determined by the system 106. For example, the system 106 may analyze the digital content (e.g., text or image) to automatically determine the association identifiers. In some embodiments, the system 106 may utilize computer vision and image recognition technologies to extract information about the digital content. This may include, but not be limited to, object detection, facial recognition, scene recognition, or the like. In some other embodiments, the system 106 may perform natural language processing (NLP) to extract keywords, entities, and sentiment analysis to identify relevant topics, entities, and emotional tone of the digital content. For example, the system 106 may use Term Frequency-Inverse Document Frequency (TF-IDF) or TextRank to extract keywords from the digital content. As another example, the system 106 may apply topic modelling techniques like Latent Dirichlet Allocation (LDA) or Non-Negative Matrix Factorization (NMF) to identify latent topics within the digital content. In some other embodiment, the system 106 may integrate with external APIs or services that provide content analysis capabilities. In some embodiments, the system 106 may pre-process the digital content by cleaning and formatting for analysis, for example, resizing and standardizing images before using computer vision techniques. Based on the digital content, the system 106 may automatically determine the association identifiers to tag the post. The tagged post may be published on any social media platform 104 via the system 106. This will be further explained in detail throughout the disclosure.

In some embodiments, the system 106 may receive the digital content from the user via the user device 102 to create a post for the social media platform 104. For example, the digital or media content may include, but not limited to, a text, an image, an audio clip, a video clip, virtual reality content, meta data, or the like. In some embodiments, user may use a text input field on the digital platform 102-1 to enter their content.

In some embodiments, the system 106 may dynamically determine one or more association identifiers corresponding to the received digital or media content. In some embodiments, a particular symbol, such as “@” may be used as a trigger for the system 106 to dynamically determine the one or more association identifiers. Alternatively, or additionally, the one or more association identifiers may be automatically determined by the system 106 while the media content is being entered by the user. In some embodiments, the system 106 may query a database (e.g., 114) to retrieve the one or more association identifiers corresponding to the media content. For example, the system 106 may use efficient search techniques or indexing to retrieve the association identifiers from the database 114. In some embodiments, the system 106 may send asynchronous requests to the database 114 to retrieve the association identifiers. Alternatively, or additionally, in some embodiments, the system 106 may dynamically determine the one or more association identifiers while the system 106 is receiving the media content from the user based on one or more correlation parameters. For example, as the user types or submits the media content, the system 106 may parse the content to identify one or more association identifiers using regular expressions or string manipulation techniques. The one or more association identifiers may be direct associations or indirect associations. The direct associations may correspond to a direct correlation between the media content and the one or more association identifiers. The indirect associations may correspond to an indirect correlation having one or more intermediary references between the media content and the one or more association identifiers. For example, an image may be associated with an ID, and the ID may be associated with a platform ID of a person to be tagged. In some embodiments, the one or more association identifiers may include, but not be limited to, an identifier of a content creator or other users corresponding to the media content on the social media platform 104, an identifier of the content creator or other users on another social media platform 104, a source of the media content, inter-related content corresponding to the media content, or the like. In some embodiments, the one or more correlation parameters may include, but not be limited to, an authorship of the media content, an ownership of the media content, inter-related content corresponding to the media content, other relationship to the media content on or off the social media platform 104 (e.g., subject of a picture), expressed interest in the media content or the inter-related content, explicit linkage of the media content, prior reference of use of the media content, prior behavior of any user (e.g., IDs), keywords, relationship to the user, similarities to prior content including, but not limited to, text, image, audio, video, VR, created and/or posted based on similarities in, but not limited to, words, formatting, composition (textual, visual, or otherwise), frequencies or other derivative models (e.g., Fourier analysis), meta data, similarities in behavior based on prior content or tagging including, but not limited to, dates, times, frequencies, responses, other users involved in the posting or interaction with the media content, external data or models, data modelling associations, third party data, random data, relationship to the user (e.g., if it is a second-degree connection or less), relationship to other IDs, or the like. In some embodiments, the association may be full, e.g., an exact match, or a partial match. For example, instead of only tagging a painter when an image of a painting is used in the post, the system 106 may tag the painter if a derivative work is used.

In some embodiments, the system 106 may tag the media content with the determined one or more association identifiers to create a modified post for the social media platform 104. In some embodiments, the system 106 may tag the media content with the one or more association identifiers and enable the user to modify the one or more association identifiers. In some other embodiments, the system 106 may disable the user to modify the one or more association identifiers. In some other embodiments, the system 106 may generate one or more recommendations for the one or more association identifiers and provide the recommendations to the user to enable the user to select the one or more association identifiers to be tagged with the media content. For example, the system 106 may implement an auto-complete or a suggestion dropdown beneath the text input field to help the user select an appropriate association identifier. In some embodiments, the system 106 may perform validation of the identified association identifiers, for example, to verify that the identified association identifier corresponds to a valid user account or stand-alone mention in the database 114. In some embodiments, the system 106 may assign weights to the recommended association identifiers based at least on their relevance to the digital content, for example, more relevant association identifiers may have higher weights. In some embodiments, numerical scores may be assigned to the association identifiers on a scale, such as 0 to 1, where 1 may indicate high relevance, and 0 may indicate low relevance. In some embodiments, relative ranking may be used to assign weights to the association identifiers. In some other embodiments, weighting techniques may take into account weighting factors such as, but not limited to, frequency, popularity, user preferences, context, temporal relevance, or the like, to assign the weights to the association identifiers. In some embodiments, the recommendations may be based on, but not limited to, user activities on the social media platforms 104, user settings, user preferences, and/or machine learning (ML), for example, only suggest IDs that may have been active in the last month. In some embodiments, the system 106 may enable the user to select the association identifier by way of, but not limited to, dropdowns, checkboxes, lists, buttons, audio confirmation, or the like. The system 106 may store the recommendations in the database 114. In some embodiments, the system 106 may associate the user profile information with the user preferences provided by the user, so that the system 106 may recommend the one or more association identifiers to a particular user based on their submitted preferences and/or settings. In some embodiments, the user may search for a specific association identifier in the database 114 via the system 106. In such a scenario, the system 106 may provide the specific association identifier to the user. In some embodiments, when the system dynamically determines the one or more association identifiers, the system 106 may store the association identifiers in the database 114 a priori to the tagging of the media content with the association identifiers.

In accordance with embodiments of the present disclosure, the system 106 may retrieve the association identifiers related to the media content from the digital database 114. It may be noted that the system 106 may contain links of association identifiers to other content stored at the digital database 114, and therefore, may have inter-related content. Therefore, when the system 106 queries the digital database 114 for one media content, the system 106 may also query the digital database 114 for content inter-related to that one media content. The system 106, while retrieving association identifiers related to that one media content, may also retrieve association identifiers of the inter-related content from the digital database 114. Association identifiers may also include, but not limited to, an e-mail, a website, a file, a combination of files, one or more files with embedded links to other files, a news group posting, a blog, a web advertisement, etc. in the context of the Internet, a common association identifier may be a web page. Web pages often include textual information and may include embedded information (such as meta data, images, hyperlinks, etc.) and/or embedded instructions (such as JavaScript, etc.). It may be appreciated that, the media content may not be required to be on the social media platform 104, for example, the association may be between an ID and a reference to the media content including, but not limited to, a link or other reference to, a subset of, a representation of, meta data for, a description or representation of, and/or a hash of the media content. In another case, the system 106 may generate new content but have an implied association. For example, if some text, such as a quote, is associated with an ID, the system 106 may generate an image of the text, and associate it with the ID.

In some embodiments, the system 106 may apply a cosine similarity function in the database 114 to identify the inter-related content corresponding to the media content. It may be understood that the cosine similarity function may measure a similarity between two vectors (e.g., content or association identifiers in this case) in the considered space. The system 106 may apply the cosine similarity function in the database 114 based on one or more predefined parameters including, but not limited to, involvement of one or more of content creators or users, subject matter of the media content, other relevant parameters, or any combination thereof. Other embodiments may include other singular or multi-dimensional vector composition or comparison of content or association identifiers.

Further, the system 106, based on tagging the media content with the determined one or more association identifiers may enable the user to publish the modified post (e.g., tagged post) on the social media platform 104. In some embodiments, the modified post may include the tagged associated identifiers as clickable links or styled mentions.

In some embodiments, the system 106 may leverage artificial intelligence (AI) or machine learning (ML) to help users write new media content, suggest inter-related content from the database 114, query the database 114 for association identifiers based on user preferences, help to identify incorrect and/or conflicting information in the database 114, generate relevant recommendations for the user, e.g., based on user preferences, settings, or activities, or the like. In some embodiments, the system 106 may leverage blockchain methods for the same.

Although a single user device 102 is depicted in FIG. 1, it will be appreciated that any number of user devices may be implemented in the present disclosure. Further, although FIG. 1 shows example components of the proposed disclosure, in other embodiments, fewer components, different components, differently arranged components, or additional functional components may be implemented than those depicted in FIG. 1.

FIG. 2 shows a block diagram 200 of an example system such as the system 106, in accordance with embodiments of the present disclosure.

Referring to FIG. 2, the functionalities of the system 106 may be incorporated in its entirety or at least partially in a server (not shown), without departure from the scope of the disclosure. The server may be implemented as a cloud server which may execute operations through web applications, cloud applications, HTTP requests, repository operations, file transfer, and the like. Other examples of the server may include, but are not limited to, a database server, a file server, a web server, a media server, an application server, a mainframe server, a cloud server, or other types of servers. In one or more embodiments, the server may be implemented as a plurality of distributed cloud-based resources by use of several technologies that are well known to those skilled in the art. In some embodiments, the system 106 may include the processor(s) 108, the memory 110, the interface(s) 112, and the database 114. In some embodiments, the system 106 may be communicatively coupled with one or more external entities such as, but not limited to, a user device 102 and one or more social media platforms 104 via a communication network 202.

In some embodiments, the processor(s) 108 may include suitable logic, circuitry, and interfaces that may be configured to execute program instructions associated with different operations to be executed by the system 106. For example, some of the operations may include, but are not limited to, receiving media content from a user, querying the database 114 for corresponding association identifiers, retrieving data corresponding to the media content, creating a post with the media content tagged with the corresponding association identifiers, updating the database 114 with the association identifiers, or the like. Several other functions may be performed by the processor(s) 108 within the scope of the current disclosure.

In some embodiments, the processor(s) 108 may be implemented as one or more microprocessors, microcomputers, microcontrollers, edge or fog microcontrollers, digital signal processors, central processing units, logic circuitries, and/or any devices that process data based on operational instructions. Examples of implementations of the processor(s) 108 may be a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or a combination thereof.

Among other capabilities, the processor(s) 108 may be configured to fetch and execute computer-readable instructions stored in the memory 110 of the system 106. The memory 110 may be configured to store one or more computer-readable instructions or routines in a non-transitory computer readable storage medium, which may be fetched and executed to create or share data packets over a network service. The memory 110 may comprise any non-transitory storage device including, for example, volatile memory such as Random-Access Memory (RAM), or non-volatile memory such as Electrically Erasable Programmable Read-only Memory (EPROM), flash memory, and the like.

In some embodiments, the interface(s) 112 may comprise a variety of interfaces, for example, interfaces for data input and output devices, referred to as input/output (I/O) devices, storage devices, and the like. The interface(s) 112 may facilitate communication for the system 106. The interface(s) 112 may also provide a communication pathway for one or more components of the system 106. Examples of such components include, but are not limited to, the database 114. In some embodiments, the database 114 may comprise data that may be either stored or generated as a result of functionalities implemented by any of the components of the system 106 such as, but not limited to, media content received from the user, user preferences, user profile information, association identifiers, or the like. In some embodiments, the database 114 may include information of users with their associated identifiers, usernames, and other relevant information. In some other embodiments, the database 114 may include user-generated posts, including the content and references to tagged association identifiers. In some embodiments, each post may have a unique identifier in the database 114.

In some embodiments, the interface(s) 112 may include suitable logic, circuitry, and interfaces that may be configured to facilitate a communication between the system 106, the user device 102, the digital platform 102-1, and the social media platforms 104 via the communication network 202. The interface(s) 112 may be implemented by use of various known technologies to support wired or wireless communication of the system 106 with the communication network 202. The interface(s) 112 may include, for example, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

In some embodiments, the communication network 202 may include, but not limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The communication network 202 may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. In some embodiments, the communication network 202 may include, but not limited to, the Internet, a cloud network, a Wireless Fidelity (Wi-Fi) network, a Personal Area Network (PAN), a Local Area Network (LAN), or a Metropolitan Area Network (MAN). Various components in the block diagram 200 may be configured to connect to the communication network 202, in accordance with various wired and wireless communication protocols.

A person of ordinary skill in the art will appreciate that the block diagram 200 may be modular and flexible to accommodate any kind of changes.

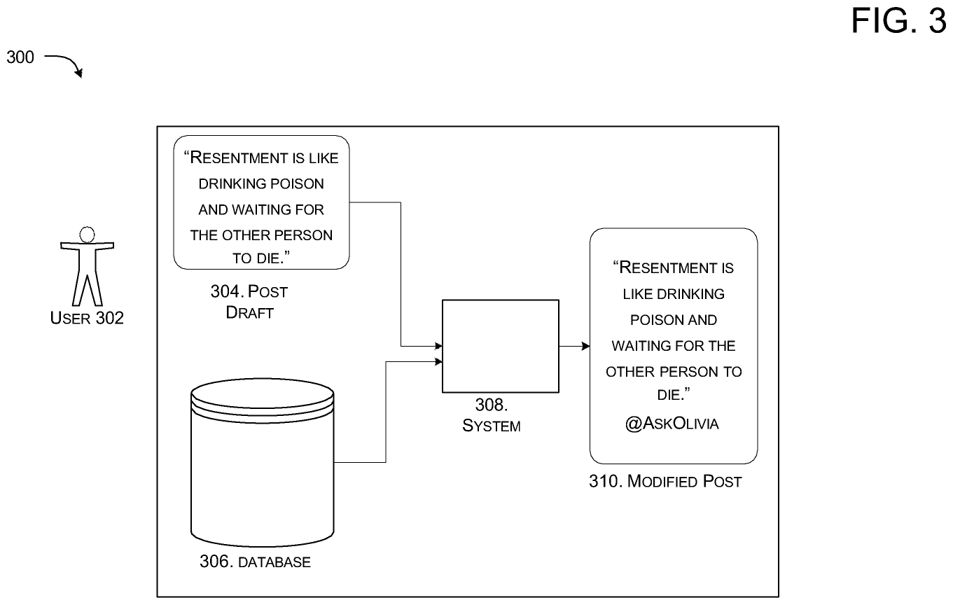

FIG. 3 shows an example representation 300 of implementing the example system (e.g., 106), in accordance with embodiments of the present disclosure.

Referring to FIG. 3, a user 302 may use a user device (e.g., 102) to post digital content as a draft at 304. The draft may be provided to the system 106 at 308. In some embodiments, the system 106 may retrieve one or more association identifiers from a digital database (e.g., 114) corresponding to the draft at 306. In some other embodiments, the system 106 may dynamically determine the one or more association identifiers corresponding to the draft. Further, the system 106 may tag the draft with the one or more association identifiers to create a modified post at 310. The user 302 may then publish the modified post at any social media platform (e.g., 104).

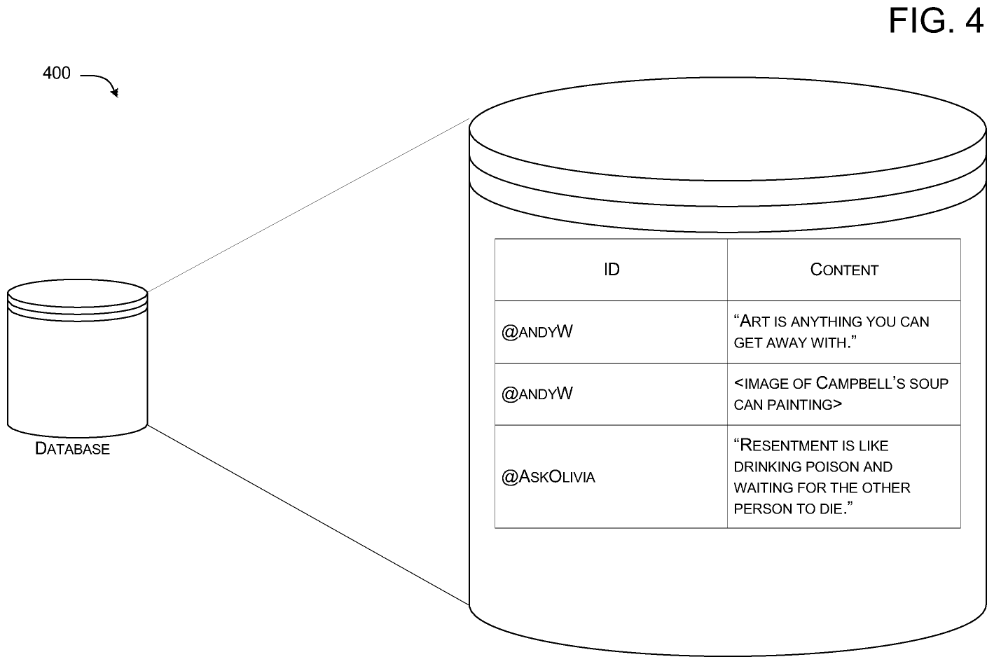

FIG. 4 shows an example representation 400 of implementing the example system (e.g., 106), in accordance with embodiments of the present disclosure.

Referring to FIG. 4, the database, as shown, may store the association identifiers, for example, associating a user ID with content. FIG. 4 shows three entries. The first entry associates ID (e.g., social media handle) with content (e.g., quote). The second entry associates the same user ID with an image (i.e., in this case, it is a description of the image, although it may also be the image itself). In the third entry, a different user ID is associated with yet another quote, which is used by the system 106, as shown in FIG. 3.

As an example, if user 1 writes a book, and user 2 wants to share a quote from the book on a social media platform 104. The present disclosure allows the user 2 to create a post which includes the quote from user 1. The system 106 may allow the user 2 to tag an ID of the user 1 in the post, which may be stored as an association identifier in the database 114. As another example, user 2 wants to share the quote from a book written by user 1. Now, user 3 is also associated with the quote from the book of user 1. Therefore, the present disclosure allows the user 2 to tag an ID of user 3 in addition to, or instead of, tagging the ID of user 1.

Therefore, the present invention provides a convenient and an easy-to-use way for users to add and/or tag digital content.

It may be appreciated that the example representations 300, 400 may be modular and flexible to accommodate any kind of changes within the scope of the present disclosure.

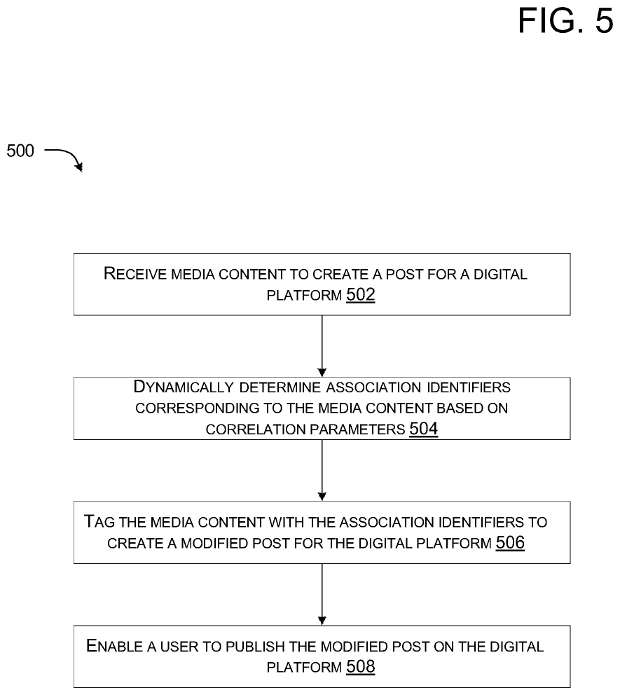

FIG. 5 shows a flow chart of an example digital content tagging method 500, in accordance with embodiments of the present disclosure.

Referring to FIG. 5, at block 502, the method 500 may include receiving media content from a user to create a post for a digital platform (e.g., social media platform 104). In some embodiments, the media content may include, but not limited to, a text, an image, an audio clip, a video clip, virtual reality content, meta data, or any combination thereof.

Further, at block 504, the method 500 may include dynamically determining one or more association identifiers corresponding to the media content based on one or more correlation parameters. In some embodiments, the method 500 may include retrieving the association identifiers from a digital database (e.g., 114). In some other embodiments, the method 500 may include dynamically determining the association identifiers while the media content is received from the user, based on the correlation parameters. The association identifiers may be direct or indirect associations. The direct associations may correspond to a direct correlation between the media content and the association identifiers. The indirect associations may correspond to an indirect correlation having one or more intermediary references between the media content and the association identifiers. In some embodiments, the association identifiers may be stored in the database 114 a priori to the tagging of the media content with the association identifiers.

Referring to FIG. 5, at block 506, the method 500 may include tagging the media content with the association identifiers to create a modified post for the digital platform. In some embodiments, the system 106 may tag the media content with the association identifiers and enable the user to modify the association identifiers. In some other embodiments, the system 106 may disable the user to modify the association identifiers. In some other embodiments, the system 106 may determine and provide recommendations for the association identifiers to the user to enable the user to select the association identifiers. The recommendations may be based on user activities, user activities, user preferences, and/or machine learning (ML).

At block 508, the method 500 may include enabling the user to publish the modified post on the digital platform.

Therefore, in accordance with embodiments of the present disclosure, the system 106 helps to enhance visibility, engagement, and relationships, among other like benefits, while also providing opportunities for growth and collaboration. For example, by tagging relevant social media handles in the media content, users are more likely to reach a wider audience. This is because some social media platforms reward tagging and related activities with better promotion of a social media posting. As another example, dynamically tagging association identifiers with the media content is an effective strategy for users to make most of their online presence and content marketing efforts, among other like advantages; when others are tagged in a post, the audience of those tagged are more likely to be exposed to the post.

It will be appreciated that the blocks shown in FIG. 5 are merely illustrative. Other suitable blocks may be used, if desired. Moreover, the blocks of the method 500 may be performed in any order and may include additional blocks.

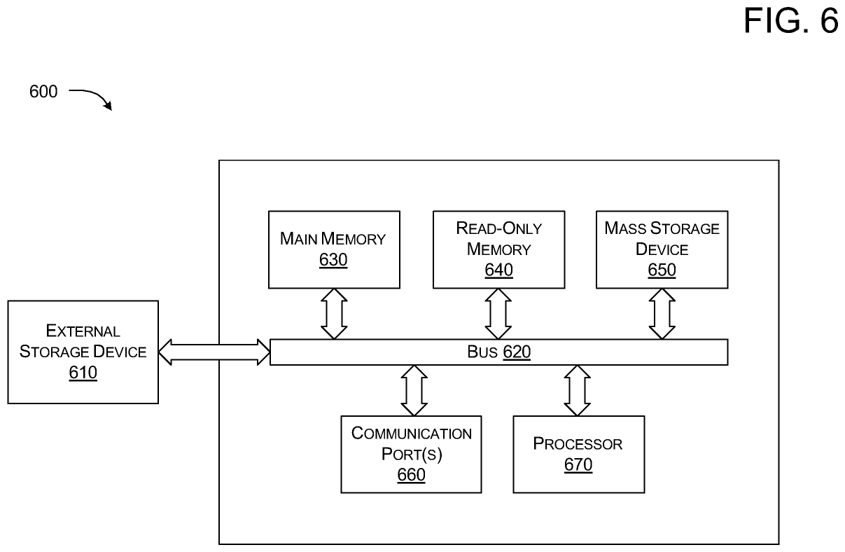

FIG. 6 illustrates an example computer system 600 in which or with which embodiments of the present disclosure may be implemented. In some embodiments, the system 106 of FIG. 1 may be implemented as the computer system 600.

As shown in FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication ports. The processor 670 may include various modules associated with embodiments of the present disclosure. The communication port(s) 660 may be chosen depending on a network, such a Local Area Network (LAN), Wide Area Network (WAN), or any network to which the computer system 600 connects. The main memory 630 may be Random-Access Memory (RAM), or any other dynamic storage device commonly known in the art. The read-only memory 640 may be any static storage device(s) e.g., but not limited to, a Programmable Read Only Memory (PROM) chips for storing static information e.g., start-up or BIOS instructions for the processor 670. The mass storage device 650 may be any current or future mass storage solution, which can be used to store information and/or instructions.

The bus 620 communicatively couples the processor 670 with the other memory, storage, and communication blocks. Optionally, operator and administrative interfaces, e.g., a display, keyboard, joystick, and a cursor control device, may also be coupled to the bus 620 to support direct operator interaction with the computer system 600. Other operator and administrative interfaces can be provided through network connections connected through communication port(s) 660. The external storage device 610 may be any kind of external hard-drives, floppy drives, or the like. Components described above are meant only to exemplify various possibilities. In no way should the aforementioned example computer system 600 limit the scope of the present disclosure.

In some embodiment, the methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor (such as 108 or 670) to perform or control performance of operations of the proposed methods. It is also contemplated that the systems described herein may perform functions or execute instructions other than those described in relation to the methods and CRSMs described herein.

Furthermore, the CRSMs described herein may store instructions corresponding to the methods described herein and may store instructions which may be performed or executed by the systems described herein. Furthermore, it is contemplated that the CRSMs described herein may store instructions different than those corresponding to the methods described herein and may store instructions which may be performed by systems other than the systems described herein.

The methods, systems, and CRSMs described herein may include the features or perform the functions described herein in association with any one or more of the other methods, systems, and CRSMs described herein.

In some embodiments, the method or methods described above may be executed or carried out by a computing system (for example, the computer system 600 of FIG. 6) including a tangible computer-readable storage medium, also described herein as a storage machine, that holds machine-readable instructions executable by a logic machine (e.g. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the following claims and their legal equivalents.

What is claimed is:

1. A system, comprising:
a processor; and
a memory operatively connected to the processor, wherein the memory comprises processor-executable instructions which, when executed by the processor, cause the processor to:
receive, from a user device associated with a user, media content to create a post for a digital platform associated with the system;
dynamically determine one or more association identifiers corresponding to the media content based on one or more correlation parameters;
tag the media content with the one or more association identifiers to create a modified post for the digital platform; and
enable the user to publish the modified post on the digital platform via the user device.

2. The system of claim 1, wherein the media content comprises at least one of: a text, an image, an audio clip, a video clip, a virtual reality content, meta data, or any combination thereof.

3. The system of claim 1, wherein the one or more association identifiers correspond to at least one of: direct associations, and indirect associations, wherein the direct associations correspond to a direct correlation between the media content and the one or more association identifiers, and wherein the indirect associations correspond to an indirect correlation having one or more intermediary references between the media content and the one or more association identifiers.

4. The system of claim 1, wherein the one or more association identifiers comprise at least one of: an identifier of a content creator or other users corresponding to the media content on the digital platform, an identifier of the content creator or other users on another digital platform, a source of the media content, inter-related content corresponding to the media content, or any combination thereof.

5. The system of claim 1, wherein to dynamically determine the one or more association identifiers, the processor is to perform one of:
retrieve the one or more association identifiers from a digital database associated with the system; and/or
dynamically determine the one or more association identifiers while the media content is received from the user device based on the one or more correlation parameters.

6. The system of claim 1, wherein the one or more correlation parameters comprise at least one of: an authorship of the media content, an ownership of the media content, inter-related content corresponding to the media content, expressed interest in the media content or the inter-related content, explicit linkage of the media content, prior reference of use of the media content, keywords, relationship to the user, or any combination thereof.

7. The system of claim 1, wherein the processor is to store the one or more association identifiers corresponding to the media content in a digital database associated with the system a priori to the tagging of the media content with the one or more association identifiers.

8. The system of claim 1, wherein to tag the media content with the one or more association identifiers, the processor is to perform:
tag the media content with the one or more association identifiers and enable the user of the user device to modify the tagged one or more association identifiers;
tag the media content with the one or more association identifiers and disable the user of the user device to modify the tagged one or more association identifiers; and/or
determine and provide one or more recommendations for the one or more association identifiers to the user to enable the user to select the one or more association identifiers.

9. The system of claim 8, wherein the one or more recommendations are determined based on at least one of: user activities on the digital platform, user settings, user preferences, and/or machine learning.

10. A computer-implemented method, comprising:
receiving, by a processor associated with a system, from a user device associated with a user, media content to generate a post for a digital platform associated with the system;
dynamically determining, by the processor, one or more association identifiers corresponding to the media content based on one or more correlation parameters;
tagging, by the processor, the media content with the one or more association identifiers to create a modified post for the digital platform; and
enabling, by the processor, the user to publish the modified post on the digital platform via the user device.

11. The computer-implemented method of claim 10, wherein the media content comprises at least one of: a text, an image, an audio clip, a video clip, a virtual reality content, meta data, or any combination thereof.

12. The computer-implemented method of claim 10, wherein the one or more association identifiers correspond to at least one of: direct associations, and indirect associations, wherein the direct associations correspond to a direct correlation between the media content and the one or more association identifiers, and wherein the indirect associations correspond to an indirect correlation having one or more intermediary references between the media content and the one or more association.

13. The computer-implemented method of claim 10, wherein the one or more association identifiers comprise at least one of: an identifier of a content creator or other users corresponding to the media content on the digital platform, an identifier of the content creator or other users on another digital platform, a source of the media content, inter-related content corresponding to the media content, or any combination thereof.

14. The computer-implemented method of claim 10, wherein dynamically determining the one or more association identifiers comprises one of:
retrieving, by the processor, the one or more association identifiers from a digital database associated with the system; and/or
dynamically determining, by the processor, the one or more association identifiers while the media content is received from the user device based on the one or more correlation parameters.

15. The computer-implemented method of claim 10, wherein the one or more correlation parameters comprise at least one of: an authorship of the media content, an ownership of the media content, inter-related content corresponding to the media content, expressed interest in the media content or the inter-related content, explicit linkage of the media content, prior reference of use of the media content, keywords, relationship to the user, or any combination thereof.

16. The computer-implemented method of claim 10, comprising storing, by the processor, the one or more association identifiers corresponding to the media content in a digital database associated with the system a priori to tagging the media content with the one or more association identifiers.

17. The computer-implemented method of claim 10, wherein tagging, by the processor, the media content with the one or more association identifiers comprises:
tagging, by the processor, the media content with the one or more association identifiers and enabling the user of the user device to modify the tagged one or more association identifiers;
tagging, by the processor, the media content with the one or more association identifiers and disabling the user of the user device to modify the tagged one or more association identifiers; and/or
determining and providing, by the processor, one or more recommendations for the one or more association identifiers to the user to enable the user to select the one or more association identifiers.

18. The computer-implemented method of claim 17, wherein the one or more recommendations are determined based on at least one of: user activities on the digital platform, user settings, user preferences, and/or machine learning.

19. A non-transitory computer readable medium comprising processor-executable instructions, which in response to execution by one or more processors, cause the one or more processors to perform or control performance of operations that comprise:
receive, from a user device associated with a user, media content to create a post for a digital platform associated with a system;
dynamically determine one or more association identifiers corresponding to the media content based on one or more correlation parameters;
tag the media content with the one or more association identifiers to create a modified post for the digital platform; and
enable the user to publish the modified post on the digital platform via the user device.

20. The non-transitory computer readable medium of claim 19, wherein the one or more processors are to perform or control performance of operations that comprise store the one or more association identifiers corresponding to the media content in a digital database associated with the system a priori to the tagging of the media content with the one or more association identifiers.
